(19) United States
(12) Patent Application Publication
(10) Pub. No.: US 2019/0168558 A1
(43) Pub. Date: Jun. 6, 2019

(54) DOUBLE WISHBONE INDEPENDENT TRAILER SUSPENSION

(71) Applicant: STEMCO PRODUCTS, INC., Charlotte, NC (US)

(72) Inventors: Paul DOLAN, Clio, MI (US); James Richard NEAL, Canton, MI (US); Thor David SABGASH, Millington, MI (US); Bradley Edward HADDIX, Millington, MI (US); Christian Eugene LOUIS, Millington, MI (US); Jason Douglas TRATO, Millington, MI (US); Jeffrey Alan GEIST, Brighton, MI (US); Donald A. RAITZER, Farmington, MI (US)

(21) Appl. No.: 16/325,147

(22) PCT Filed: Aug. 21, 2017
(86) PCT No.: PCT/US2017/047740

§ 371 Date: Feb. 12, 2019

Related U.S. Application Data
(60) Provisional application No. 62/378,077, filed on Aug. 22, 2016.

(51) Int. Cl. B60G 5/04; B60G 7/00; B62D 21/02

(52) U.S. Cl. CPC B60G 5/04; B60G 7/001; B62D 21/02; B60G 2200/144; B60G 2300/042; B60G 2204/126; B60G 2206/0114; B60G 2300/02; B60G 2202/1524

(57) ABSTRACT

Technology is provided for a double wishbone independent trailer suspension. The suspension includes a slider frame configured for attachment to a semi-trailer. The slider frame includes a longitudinal central beam and upper and lower clevis brackets located on opposite sides of the central beam. A pair of upper wishbones are attached to the upper clevis brackets and at least one air spring is positioned between the slider frame and each upper wishbone. A pair of lower wishbones are attached to the lower clevis brackets and a pair of spindles are each pivotably attached to a corresponding upper wishbone and a corresponding lower wishbone.

### CROSS-REFERENCE TO RELATED APPLICATIONS

This application claims the benefit of and priority to U.S. Patent Application No. 62/378,077, filed Aug. 22, 2016, the disclosure of which is incorporated herein by reference in its entirety.

### TECHNICAL FIELD

This patent application is directed to vehicle suspension and, more specifically, independent trailer suspension.

### BACKGROUND

Traditional trailer suspension is based on one or more solid axles that connect the left and right hand wheels together. The axles are mounted on either a set of leaf springs or on a pair of trailing arms supported by pneumatic air springs, for example. A disadvantage of this arrangement is that it couples the movement of the left and right hand side wheels, which can cause tire wear and roll instability.

### BRIEF DESCRIPTION OF THE DRAWINGS

Embodiments of the double wishbone independent trailer suspension introduced herein may be better understood by referring to the following Detailed Description in conjunction with the accompanying drawings, in which like reference numerals indicate identical or functionally similar elements:

FIG. 1 is a side view in elevation of a representative semi-trailer truck.

FIG. 2 is an isometric view of a double wishbone independent trailer suspension according to a representative embodiment.

FIG. 3 is an end view of the double wishbone independent trailer suspension introduced in FIG. 2.

FIG. 4 is a top plan view of the double wishbone independent trailer suspension shown in FIGS. 2 and 3.

FIG. 5 is a side view in elevation of the double wishbone independent trailer suspension shown in FIGS. 2-4.

FIG. 6 is a partial isometric view of the suspension sub-frame.

FIG. 7 is an isometric view of the spindle and wishbone arms as viewed from the spindle.

FIG. 8 is an isometric view of the spindle and wishbone arms as viewed from the wishbone arms.

FIG. 9 is an isometric view of the upper wishbone.

FIG. 10 is an isometric view of the lower wishbone.

FIG. 11 is an isometric view of the spindle.

The headings provided herein are for convenience only and do not necessarily affect the scope or meaning of the claimed embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to limit the embodiments described. On the contrary, the embodiments are intended to cover all modifications, equivalents, and alternatives falling within the scope of the embodiments as defined by the appended claims.

### DETAILED DESCRIPTION

### Overview

A double wishbone independent trailer suspension is disclosed. In an embodiment, the double wishbone suspension includes a slider frame configured for attachment to a semi-trailer. The slider frame includes a longitudinal central beam and upper and lower clevis brackets located on opposite sides of the central beam. A pair of upper wishbones are attached to the upper clevis brackets and at least one air spring is positioned between the slider frame and each upper wishbone. A pair of lower wishbones are attached to the lower clevis brackets and a pair of spindles are each pivotably attached to a corresponding upper wishbone and a corresponding lower wishbone.

### GENERAL DESCRIPTION

Various examples of the device and systems introduced above will now be described in further detail. The following description provides specific details for a thorough understanding and enabling description of these examples. One skilled in the relevant art will understand, however, that the techniques discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

Traditional semi-trailer suspension is based on one or more solid axles that connect the left and right hand wheels together. The axles are mounted on either a set of leaf springs or on a pair of trailing arms supported by pneumatic air springs, in the case of an air ride system. A disadvantage of this arrangement is that it couples the movement of the left and right hand side wheels. Therefore, in an asymmetric loading condition such as a single wheel bump or lateral weight transfer under cornering, it is not possible for the single loaded wheel to move without having an effect on its opposite paired wheel. Due to the geometry of the solid axle based suspension, this movement when viewed from above the vehicle, will tend to create a rotation in the axle that introduces a steering input. This roll steer input typically pulls the trailer in the direction of the loaded wheel. Thus, in a situation where the trailer is cornering, the roll steer will act to pull the trailer deeper into the turn, potentially creating roll instability.

Coupling the wheels together also creates additional tire wear because any motion of one wheel will be transferred to its oppositely paired wheel which leads to increased tire scrubbing of the second wheel. Also, the solid axle suspension typically has a high unsprung mass which means the suspension will be less able to follow undulations in a road surface resulting in the additional possibility of wheel hop and other undesirable wheel movements that contribute to tire scrubbing and ultimately lower tire life.

In the case of traditional air ride suspensions, the solid axle is mounted on a pair of trailing arms that constrain the movement of the axle along the circumference of an arc. The axis of this arc is perpendicular to the longitudinal axis of the trailer. Under braking, this allows the wheel to hop reducing the vertical load on the wheel, in turn reducing the effectiveness of the braking force generated by the braking system and thus reducing the potential stopping distance of the vehicle.

The disclosed double wishbone suspension resolves these issues in at least two ways. First, it is an independent system that decouples the left and right side wheels. This means that the overall suspension has a lower unsprung weight for each wheel, thus allowing both wheels to better follow the variations in the road surface. By decoupling the left and right wheels there is also no interaction between them thus minimizing a potential source of tire wear. It also eliminates any roll steer effects as asymmetric deflection of suspension does not generate a steering input. Secondly, the hinge mechanism of this system is parallel to the longitudinal axis of the vehicle so under braking action, wheel movement does not reduce the braking force generated at the tire contact patch.

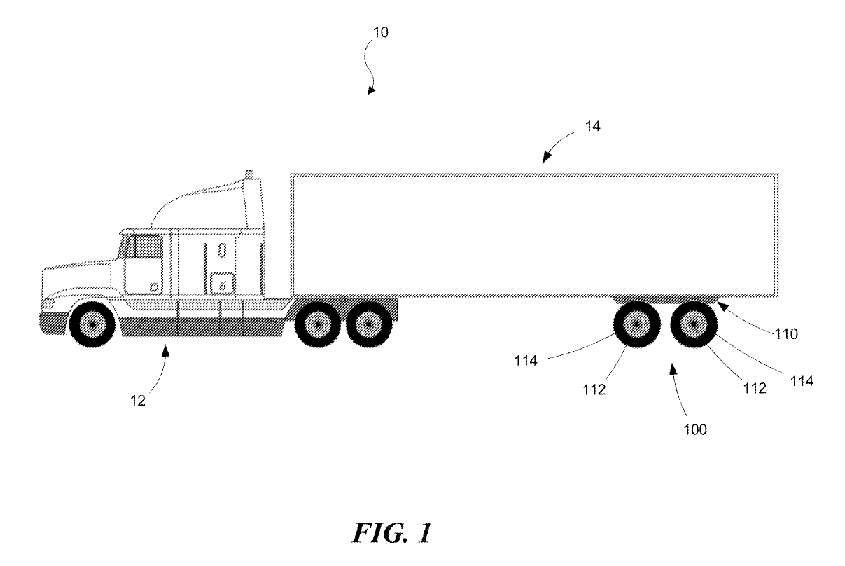

FIG. 1 is a schematic representation of a semi-trailer truck 10 including a tractor unit 12 connected to a semi-trailer 14. Semi-trailer 14 includes a double wishbone independent trailer suspension 100 according to a representative embodiment. The double wishbone suspension 100 includes a slider frame 110 that is interchangeable with a conventional suspension system that connects to the two main frame rails of the trailer chassis (not shown). The double wishbone suspension 100 includes four spindles 112 each carrying two wheels 114. In some embodiments, the slider frame 110 connects to the two main frame rails of the trailer chassis so that the entire suspension can be moved along the length of the chassis. This variation allows the driver to adjust the positioning of the trailer's wheels to compensate for variations in the type and load distribution of the cargo the trailer is carrying. In other embodiments, the slider frame 110 is integrally mounted (e.g., welded or bolted) to the trailer chassis.

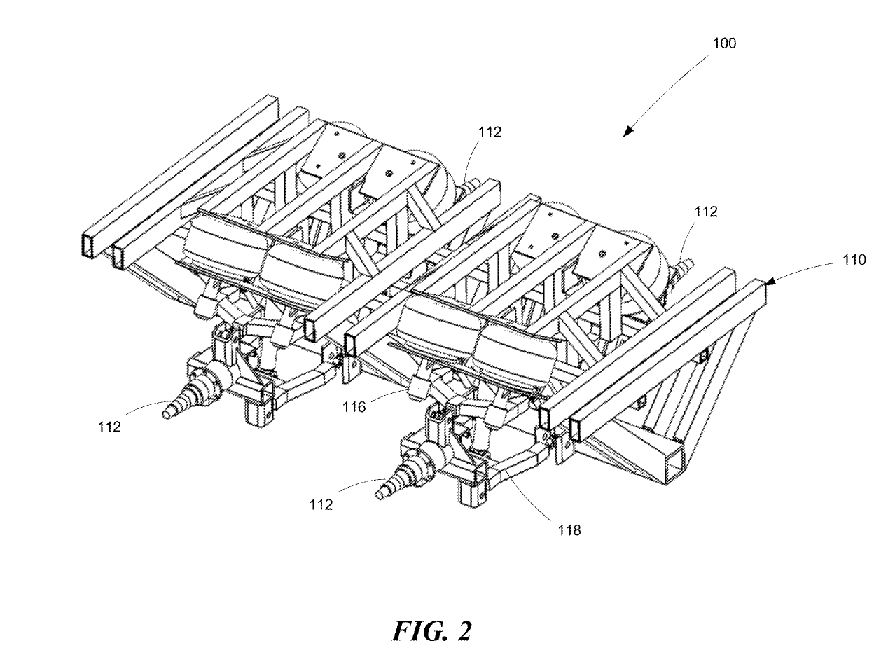

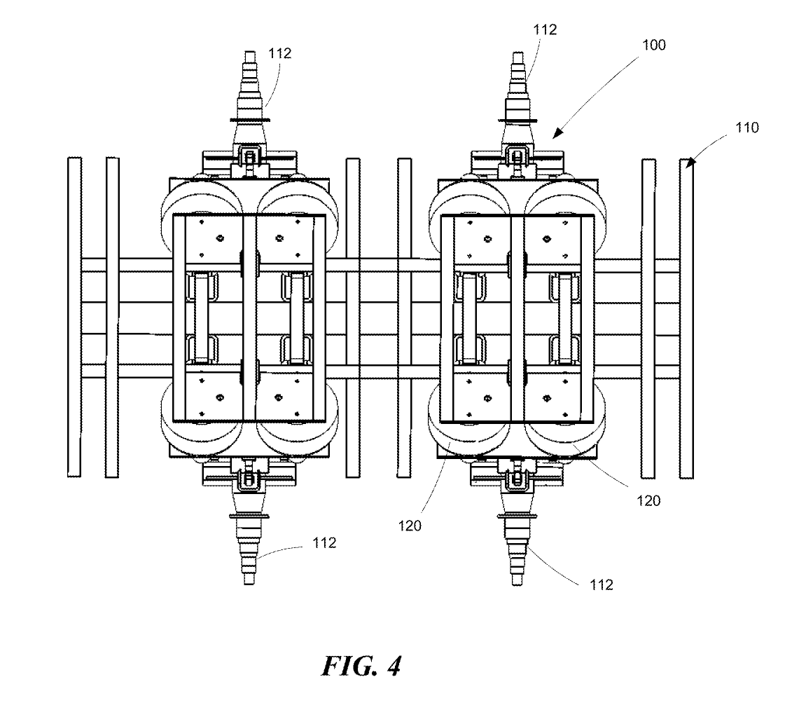

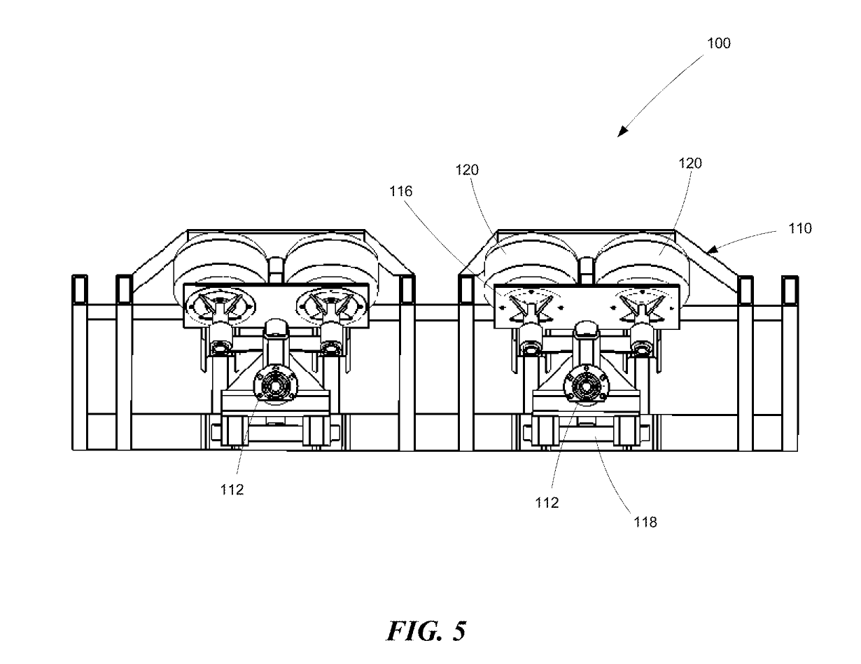

With reference to FIGS. 2-5, the illustrated embodiment of the double wishbone suspension 100 includes four spindles 112 (wheels omitted for clarity) suspended from the sub-frame or slider frame 110. Because all four spindles 112 are suspended from the slider frame 110 using the same double wishbone arrangement, a description of one is equally applicable to all four spindles 112. Furthermore, although the embodiments disclosed herein are described with respect to a tandem axle (e.g., two pairs of opposed spindles), the disclosed technology can be applied to single axle suspensions (e.g., one pair of opposed spindles) or suspensions with more than two axles.

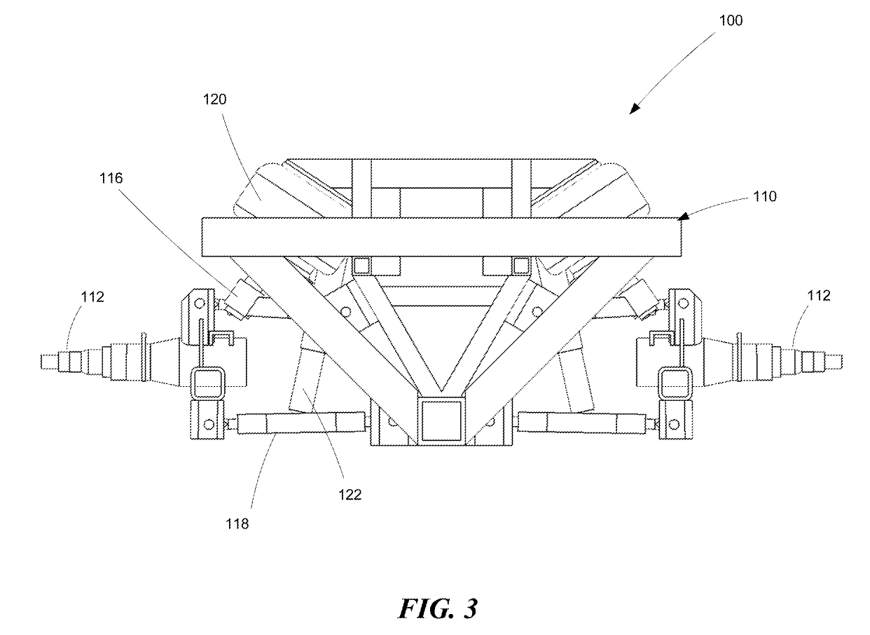

An upper control arm or wishbone 116 and a lower control arm or wishbone 118 extend from the slider frame 110 to the spindle 112. As perhaps best shown in FIG. 3, a pair of air springs 120 are mounted on the slider frame 110 and connect to the upper wishbone 116 to support the trailer's weight. The dual air spring arrangement provides enhanced load capabilities in a relatively compact envelope for positioning in the slider frame 110. A shock absorber 122 extends between the slider frame 110 and the lower wishbone 118 to help damp and control the movement of the double wishbone suspension.

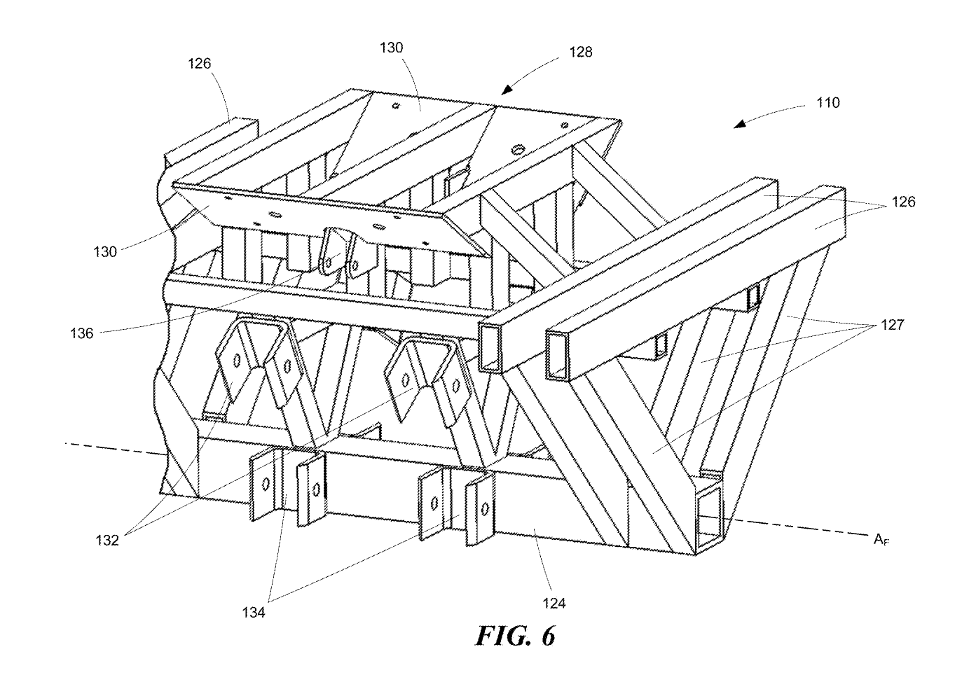

As shown in FIG. 6, the slider frame 110 comprises a weldment including a central beam 124 extending along a frame axis A_{F}. The frame axis A_{F} is substantially parallel to a longitudinal axis of the trailer's chassis. Multiple transvers beams 126 are connected to the central beam 124 with braces 127. Various additional connecting members join the frame members together and provide mounting points for the suspension system components as shown in the figure. The slider frame 110 includes upper and lower clevis brackets 132 and 134, respectively. The slider frame 110 also includes an air spring mount 128 with left and right angled air spring plates 130. The slider frame 110 also includes upper shock mounts 136 adjacent the air spring mounts 128. Although a particular frame structure is disclosed herein, other arrangements of beams and connecting members can be used without deviating from the scope of the disclosed technology. Furthermore, in some embodiments, the upper and lower clevis brackets 132, 134, air spring mount 128, and upper shock mount 136 can be attached (e.g., bolted or welded) directly to the trailer chassis rather than a separate sub-frame (e.g., slider frame).

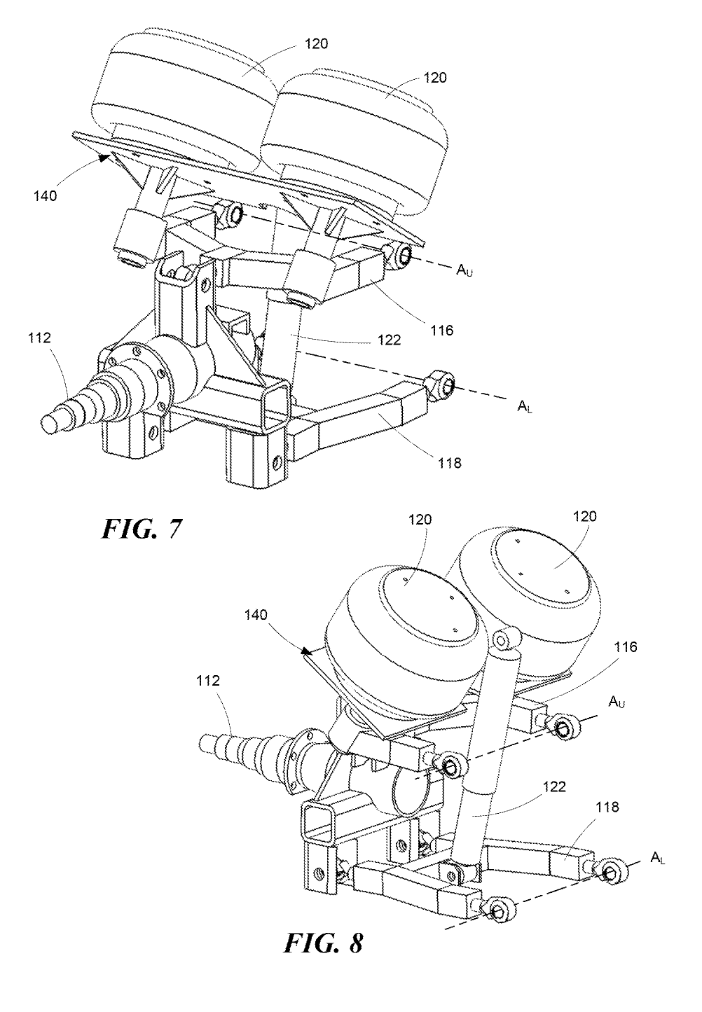

With further reference to FIGS. 7 and 8, the upper wishbone 116 attaches to the upper clevis brackets 132 for rotation about an upper axis A_{U}. Similarly, the lower wishbone 118 attaches to the lower clevis brackets 134 for rotation about a lower axis A_{L}. The upper and lower axes A_{U}, A_{L} are substantially parallel to each other as well as the frame axis A_{F}. The wishbones can be fastened to their respective clevis brackets with suitable bolts, for example. The upper wishbone 116 includes an air spring mount 140 positioned at an angle corresponding to an associated air spring plate 130 of slider frame 110 (FIG. 6). The angled air spring plate 130 and angled spring mount 140 compress the air spring 120 along its axis throughout a majority of the suspension travel. The air springs 120 can be attached to the mounting plates with suitable fasteners (not shown). As shown in FIG. 8, the shock absorber 122 is connected at a first end to the lower wishbone 118. The second end of the shock absorber is connected to the upper shock mount 136 (FIG. 6) of slider frame 110.

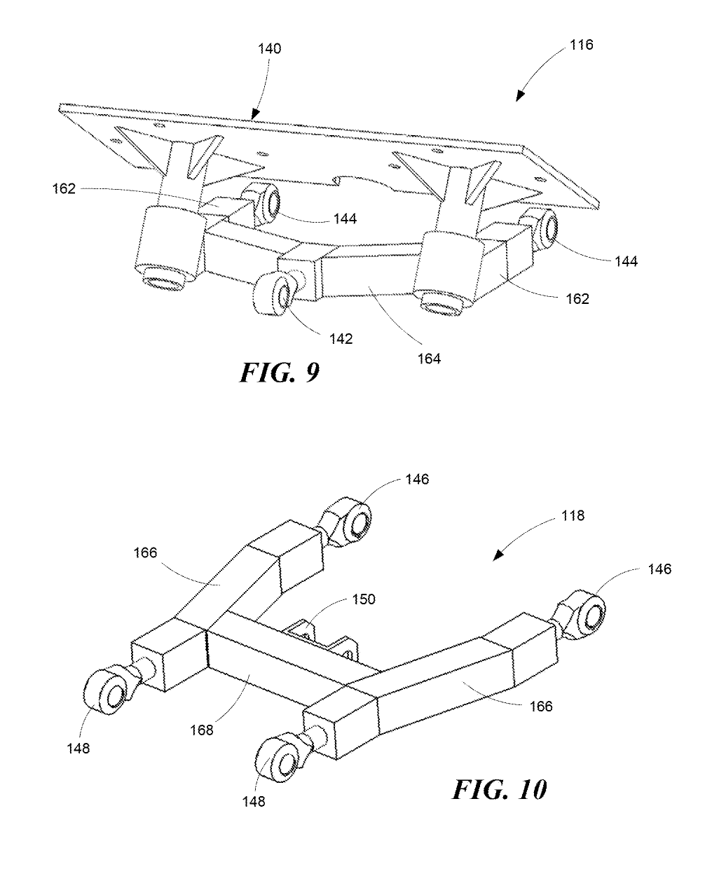

The upper wishbone 116 comprises a weldment including a pair of arms 162 interconnected with a cross-brace 164 as shown in FIG. 9. Each arm 162 includes an inner rod end 144 threaded into the arm for connection to the upper clevis brackets 132 (FIG. 6) of the slider frame 110. The cross-brace 164 includes an outer rod end 142 for connection to the spindle 112 (FIGS. 7 and 8). As shown in FIG. 10, the lower wishbone 118 comprises a weldment including a pair of arms 166 interconnected with a cross-brace 168. Each arm 166 includes an inner rod end 146 for connection to the spindle 112 and an outer rod end 148 for connection to the lower clevis brackets 134 (FIG. 6). A lower shock mount 150 is positioned on the cross-brace 168 for mounting the shock absorber 122 (FIGS. 7 and 8). The rod ends (142, 144, 146, and 148) of the upper and lower wishbones are connected to their respective clevis brackets and spindle with suitable bolts, for example. As used herein, the term wishbone generally refers to upper and lower control arms regardless of whether they resemble a wishbone or not. For example, the upper control arm 116 has a triangular shape resembling a wishbone. However, the lower control arm 118 resembles an H. Nevertheless, both are referred to herein as wishbones.

As can be appreciated with reference to FIGS. 9 and 10, the upper and lower wishbones 116, 118 directly connect to the spindle 112 at three points of contact (i.e., rod ends 142 and 148) to prevent rotation of the spindle relative to the slider frame 110, thereby simplifying the suspension for use on a trailer which does not need steering capabilities. However, in some embodiments, the double wishbone suspension can be converted to a steerable configuration. In some embodiments, the double wishbone suspension can also be converted to a lift axle with the addition of suitable air actuators connected to at least one of the upper or lower wishbones.

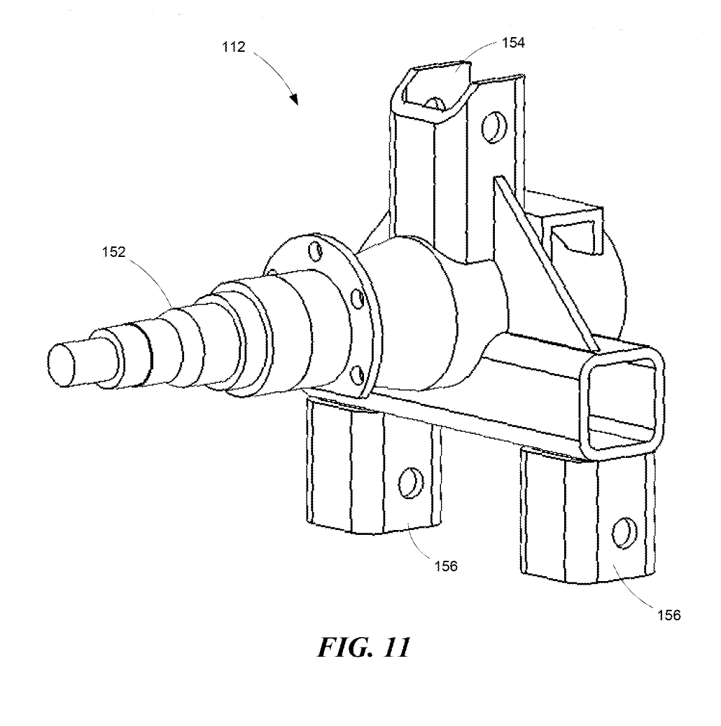

It should be appreciated that the rod ends (142, 144, 146, and 148) are threaded into their respective wishbones, thereby providing for wheel alignment adjustments, including for example camber and toe adjustment, also caster for steerable configurations. Although, the suspension pivots are shown and described as rod ends, other rotating or pivoting joint mechanisms can be used. As shown in FIG. 11, the spindle 112 comprises a weldment including an axle portion 152 attached to an upper spindle clevis 154 and two lower spindle devises 156 configured to receive the rod ends of the upper and lower wishbones (116, 118).

In some embodiments, the double wishbone independent trailer suspension can include pneumatic controls to adjust the ride height of the suspension, compensate for varying loads, and to further enhance roll stability. For example a suitable pneumatic system is described in co-pending U.S. Patent Application No. 62/378,081 (Attorney Docket No. 89143-8081.US00), filed Aug. 22, 2016, entitled PNEUMATIC ANTI-ROLL SYSTEM, the disclosure of which is incorporated herein by reference in its entirety.

In light of the foregoing, the double wishbone suspension provides the following improved features for a trailer suspension system: increased suspension mobility freedom by removing the solid axle constraint between the left and right wheel sets; shifts wheel hop vibration mode frequency away from low ground frequency excitation and removes the ground excitation of pendulum based trailing arm suspension; provides smoother ride quality caused by arbitrary left/right road profile excitation; removes roll steer and truck trailer lateral instability causing trailer rollover accidents; provides steerable trailer wheels for improved vehicle handling and stability in turns and improved tire wear with turning radius center of curvature; provides access to lower trailer design center of gravity height and improved vehicle stability; and provides for future suspension feedback control applications like electronic stability control. The disclosed double wishbone suspension also provides customer continuous improvement features with adjustment of upper and lower control arm geometry that affect: wheel toe and camber angles; trailer roll control associated with alternative left/right jounce/rebound; aftermarket suspension customization for customer specific ride and handling profiles and trailer response; and tuning of wheel hop and roll vibration modes.

Although a particular representative embodiment of the double wishbone suspension is described herein, it should not be interpreted as limiting and other embodiments and variations are possible. For example, the following features can be varied without deviating from the scope of the disclosed technology: total number of axles; location of each axle; track; overall width; ride height; ground clearance; jounce and rebound suspension travel either individually or both directions; load capacity; ride quality; handling characteristics; steerable axles; lift axles; steerable and lift axles combined; strength of individual components; weight of individual components; method of manufacture of individual components; and durability of individual components.

### REMARKS

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

What is claimed is:

1. A double wishbone independent trailer suspension, comprising:
a slider frame configured for attachment to a semi-trailer, the slider frame including a longitudinal central beam and upper and lower clevis brackets located on opposite sides of the central beam;
a pair of upper wishbones each attached to corresponding upper clevis brackets;
at least one air spring positioned between the slider frame and each upper wishbone;
a pair of lower wishbones, each attached to corresponding lower clevis brackets; and
a pair of spindles each pivotably attached to a corresponding upper wishbone and a corresponding lower wishbone.

2. The suspension of claim 1, wherein the pair of upper wishbones and the pair of lower wishbones are pivotably attached to the respective upper and lower clevis brackets with adjustable rod ends.

3. The suspension of claim 1, wherein the at least one air spring comprises two air springs.

4. The suspension of claim 1, further comprising a pair of shock absorbers each extending between the slider frame and a corresponding one of the pair of lower wishbones.

5. The suspension of claim 1, wherein the slider frame comprises a weldment and the central beam extends along a frame axis substantially parallel to a longitudinal axis of the semi-trailer.

6. The suspension of claim 5, wherein the upper wishbones are attached to the upper clevis brackets for rotation about an upper axis and the lower wishbones are attached to the lower clevis brackets for rotation about a lower axis.

7. The suspension of claim 6, wherein the upper axis, the lower axis, and the frame axis are substantially parallel to each other.

8. The suspension of claim 1, wherein the slider frame includes an air spring mount with left and right angled air spring plates, and wherein the upper wishbones each include an air spring mount positioned at an angle corresponding to an associated air spring plate, whereby the air springs are compressed along their respective axes throughout a majority of the suspension travel.

9. The suspension of claim 1, wherein the pair of spindles each comprises a weldment including an axle portion attached to an upper spindle clevis and two lower spindle devises each configured to connect to the upper and lower wishbones, respectively.

10. The suspension of claim 1, wherein the pair of upper wishbones and the pair of lower wishbones are pivotably attached to the respective upper and lower spindle clevis brackets with adjustable rod ends.

11. A double wishbone independent trailer suspension, comprising:
a slider frame configured for attachment to a semi-trailer, the slider frame including a longitudinal central beam and upper and lower clevis brackets located on opposite sides of the central beam;
a pair of upper wishbones each attached to corresponding upper clevis brackets;
a pair of air springs positioned between the slider frame and each upper wishbone;
a pair of lower wishbones, each attached to corresponding lower clevis brackets;
a pair of shock absorbers each extending between the slider frame and a corresponding one of the pair of lower wishbones; and
a pair of spindles, each comprising a weldment including an axle portion attached to an upper spindle clevis and two lower spindle clevises each configured to pivotably connect to the upper and lower wishbones, respectively, with adjustable rod ends.

12. The suspension of claim 11, wherein the pair of upper wishbones and the pair of lower wishbones are pivotably attached to the respective upper and lower clevis brackets with adjustable rod ends.

13. The suspension of claim 11, wherein the slider frame comprises a weldment and the central beam extends along a frame axis substantially parallel to a longitudinal axis of the semi-trailer.

14. The suspension of claim 13, wherein the upper wishbones are attached to the upper clevis brackets for rotation about an upper axis and the lower wishbones are attached to the lower clevis brackets for rotation about a lower axis, and wherein the upper axis, the lower axis, and the frame axis are substantially parallel to each other.

15. The suspension of claim 11, wherein the slider frame includes an air spring mount with left and right angled air spring plates, and wherein the upper wishbones each include an air spring mount positioned at an angle corresponding to an associated air spring plate, whereby the air springs are compressed along their respective axes throughout a majority of the suspension travel.
